(19) United States
(12) Patent Application Publication
(10) Pub. No.: US 2011/0259621 A1
(43) Pub. Date: Oct. 27, 2011

(54) Slide Hammer Stake Driver

(75) Inventors: James D. Oberg, Eagle Bend, MN (US); Robert H. Lusty, Alexandria, MN (US)

(73) Assignee: BAC INDUSTRIES, INC., Minnetonka, MN (US)

(21) Appl. No.: 13/094,055

(22) Filed: Apr. 26, 2011

Related U.S. Application Data
(60) Provisional application No. 61/327,777, filed on Apr. 26, 2010.

(51) Int. Cl. B25D 1/16

(52) U.S. Cl. 173/133

(57) ABSTRACT

The present invention comprises a steel outer tubular sleeve cooperating with an inner steel rod that is dimensioned to slide relative to the outer sleeve. In a first embodiment, a steel slug is welded in the sleeve at its upper end and designed to strike an upper end of the inner steel rod. In an alternative embodiment, the steel slug is welded in the sleeve at its lower end and designed to be struck by the lower end of the inner steel rod. Completing the assembly is an attachment member that in the first embodiment is removably attached to the lower end of the inner steel rod and that in the alternative embodiment is removably attached to the lower end of the outer tubular member. The attachment member is designed to hold a stake of a given cross-sectional dimension.

### REFERENCE TO RELATED APPLICATIONS

This application is based upon and claims priority to the filing date of provisional application Ser. No. 61/327,777, filed Apr. 26, 2010, the contents of which are hereby incorporated by reference.

### BACKGROUND OF THE INVENTION

1. Field of the Invention

The present invention relates generally to hand tools to be used in land development, construction and landscaping industries for placing marker stakes and the like in the ground, and more particularly to a slide hammer style apparatus that can be used to drive stakes into the ground from an upright position.

2. Discussion of the Prior Art

In laying out plots of land for housing and commercial building development, surveyors, construction workers and landscaping personnel are frequently required to lay out boundaries, guidelines and other markers using wooden, plastic and metal stakes that must be pounded into the ground. Typically, a carpenter's hammer may be used to drive the stake into the ground which requires the user to assume a kneeling position next to the stake at least within arms reach thereof. With relatively dry, compact earth, the stake driving operation may require several hammer strokes and the stake is often fragmented or the end mushroomed by the repeated hammer blows.

Accordingly, a need exists for a way to drive stakes into the ground from a more comfortable standing position and which will not split and fragment the stake as it is being driven into the earth.

### SUMMARY OF THE INVENTION

The present invention comprises a slide hammer stake driver kit in which an elongated outer tubular member with upper and lower ends has an inner rod member reciprocally slidable therein, the inner rod also having first and second ends. A resilient, shock-absorbing handle grip is affixed to an upper end portion of one of the outer tubular member and the inner rod member. A weighted anvil is disposed within the outer tubular member proximate either the upper or the lower ends thereof The anvil adapted to be impacted by one of the ends of the inner rod member upon reciprocal up and down strokes of the outer tubular member with respect to the inner rod member. Completing the kit is a plurality of attachment members that can be individually, removably connected to the lower end of either the outer tubular member or the inner rod member. These attachment members comprise a hollow parallelepipeds defining a chamber having an open bottom and each adapted to contain a stake of a different cross-sectional shape and dimension.

In use, a particular attachment member corresponding to the cross-sectional shape of the stake to be driven is affixed to a lower end portion of one of the outer tubular member or the inner rod member and with the upper end of the stake inserted into the hollow chamber. The user will then reciprocally stroke the inner rod member relative to the outer tubular member to deliver impacts to the attachment member and thus to the stake to drive it into the ground. Because the upper end of the stake is confined in the hollow chamber as it is forced into the ground, there is less tendency for the stake to mushroom or splinter.

### DESCRIPTION OF THE DRAWINGS

The foregoing features, objects and advantages of the invention will become apparent to those skilled in the art from the following detailed description of a preferred embodiment where like numerals in the several views refer to corresponding parts.

FIG. 1 is a front view of a first embodiment of the invention;

FIG. 2 is a partial broken-away view of the upper end portion of the embodiment of FIG. 1;

FIG. 3 illustrates the components of a typical slide hammer stake driver kit in accordance with the present invention; and

FIG. 4 is a section view of an alternative embodiment of the present invention.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

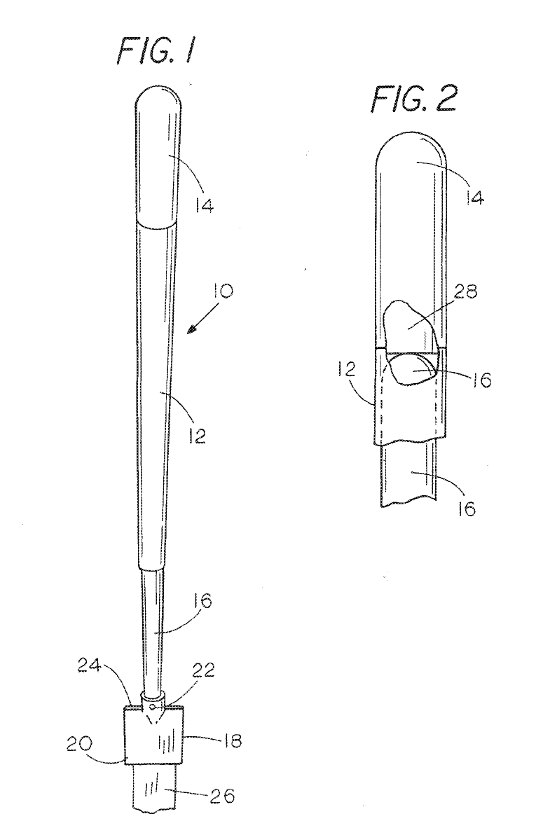

Referring to FIG. 1, a first embodiment of a slide hammer stake driver is indicated generally by numeral 10 and is seen to comprise an outer steel tubular member 12 having a relatively soft, plastic handgrip 14 covering an upper end portion of the tubular member 12. Reciprocally slidable within the lumen of the outer tubular member 12 is a steel inner rod member 16 and fastened to a lower end of rod member 16 is an attachment member 18 in the form of a hollow rectangular parallelepiped with an open bottom end 20, a closed upper end and a tubular socket 22 projecting longitudinally from the upper closed end thereof. The socket 22 is dimensioned so as to slidingly fit over the bottom end of the inner rod member 16. An aperture is drilled diametrically through the socket 22 and the lower end portion of the inner rod member 16 such that a fastener 24, such as a bolt, may pass through the aligned holes to secure the attachment member 18 to the lower end of the inner rod member 16.

As can be seen in FIG. 1, a wooden or plastic stake 26 of a generally rectangular cross-section is fitted into the chamber of the attachment member 18 via its open end 20.

Referring to FIG. 2, which shows the upper end portion of the assembly of FIG. 1, the handgrip 14 preferably comprises an elastomeric sleeve exhibiting a relatively high coefficient of friction. Contained within the upper end of the outer tubular member 12 is a weighted anvil 28 that is designed to impact an upper end of the inner rod member 16. The anvil preferably comprises a steel plug of a predetermined length and weight fitted into the upper end portion of the outer tubular member 12. From what has thus far been described, those skilled in the art will appreciate that in use the stake 26 will be fitted into the attachment member 18 with a pointed end of the stake (not shown) abutting the ground surface. Next, the user will grip the handgrip 14 with one hand while steadying the tool 10 with his other hand to hold it in a vertical orientation. The outer tubular member will be raised upward and then forcefully thrust downward such that the upper end of the inner rod member 16 is impacted by the anvil 28 to deliver a substantial downward force to the inner rod member 16 and to the stake. Repeated strokes will serve to drive the stake into the ground. Once firmly placed in the ground, the tool is lifted from the exposed end of the stake leaving the stake in place.

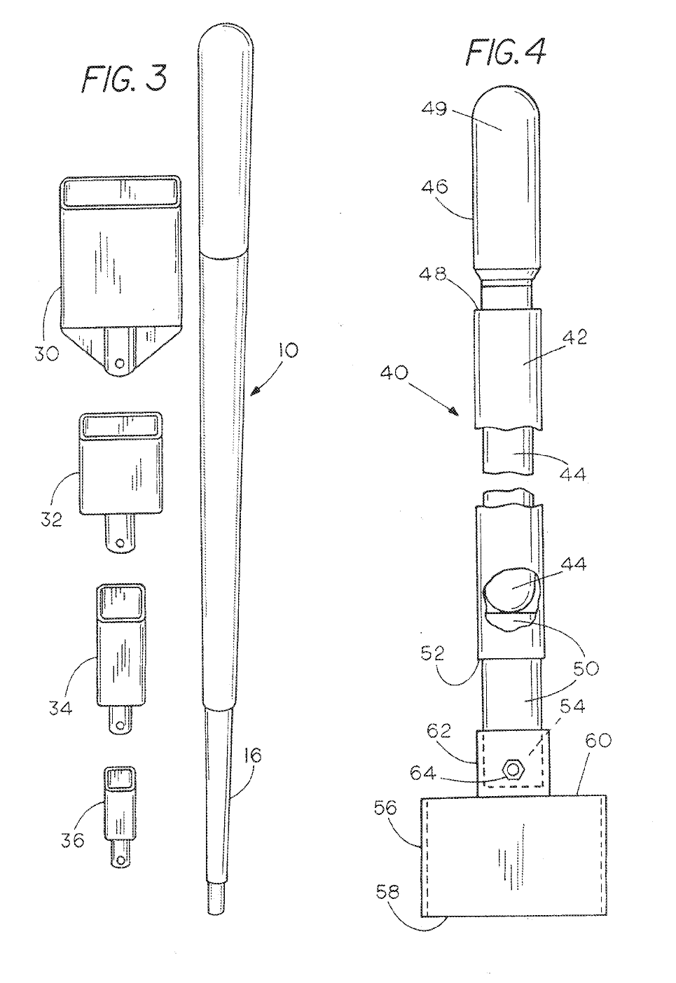

FIG. 3 illustrates a slide hammer stake driver kit including the slide hammer assembly 10 of FIG. 1 and a plurality of attachments 30-36. Each of these attachments is designed to be fastened to the lower end of the inner rod member 16 in the manner previously described. The hollow, rectangular, parallelepiped attachments 30 and 32 are designed for driving stakes having a generally rectangular cross-section of differing dimensions. Attachments 34 and 36 are more particularly designed for driving stakes of square or round cross-section.

With no limitation intended, the outer tubular member may have an outer diameter of 1 9/16^{th} inches and an inner diameter of 1⅜^{th} inches and be about 28½inches in length. The anvil 28 may be about 4½ inches long.

Again, without limitation, the inner rod member 16 be about 39 inches in length and 1 5/16^{th} inches in diameter. The combined weight of the outer tubular member and the inner rod member with the attachment 30 affixed to the lower end of the inner rod member may total about 15 pounds. The outer tubular member 12 with its inner anvil 28 typically weights about 8 pounds. Given the length of stroke achievable, the weights involved and the speed of descent of the outer tubular member with respect to the inner rod member, it can be seen that a substantial momentum force may be delivered to the stake to force it into the ground.

FIG. 4 illustrates an alternative embodiment of the slide hammer stake driver of the present invention. It is indicated generally by numeral 40 and again includes an outer tubular member 42 and an inner rod member 44 whose upper end 46 extends out beyond the upper end 48 of the outer tubular member 42. The upper end of the inner rod member 46 is also preferably coated or otherwise covered with a resilient elastomeric sheath 49 exhibiting anon-slip characteristic. Disposed within the lumen of the outer tubular member 42 proximate its lower end is an anvil member 50 that is welded in place within the outer tubular member and projects downward beyond the lower end 52 of the outer tubular member 42.

Fastened to the lower end portion 54 of the anvil member 50 is an attachment 56 like one of those shown in the view of FIG. 3. It has a chamber of rectangular cross-section, an open bottom 58 and a closed upper end 60 to which is welded a socket member 62 for receiving the lower end portion 54 of the anvil 50 therein. A through-bolt, as at 64, is used to releasably secure the attachment 56 to the anvil 50.

In FIG. 4, the outer tubular member 42 is broken away to show how the lower end portion 44 of the inner rod member cooperates with the anvil 50 to deliver a downward blow to the upper end of a stake placed within the chamber of the attachment 56. More particularly, in use, the operator will grasp the handle portion 46 with one hand and the outer tubular member 42 with his/her other hand and then will slidingly raise the inner tubular member upwards for a given distance, such that the lower end of the inner rod member 44 is a foot or so above the surface of the anvil 50. Then, the user will forcefully thrust the inner tubular member 44 downward causing the lower end thereof to impact the anvil and thereby deliver a downward driving force on a stake positioned within the attachment member 56.

In implementing the embodiment of FIG. 4, the outer tubular member may be about 33 inches in length and the overall length of the inner rod member less its handle may be about 34 inches in length. The handle portion of the inner rod member 44 extending out beyond the upper end of the outer tubular member 42 may be approximately 10 inches in length.

The weight of the inner rod member preferably is about 7 pounds, which has been found to be effective in delivering an impact force to a stake sufficient to drive it into the earth as repeated strokes are delivered via the raising and forceful lowering of the inner rod member 44 against the anvil 50 to which the attachment 56 is connected.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A slide hammer stake driver comprising, in combination:
(a) an elongated outer tubular member having upper and lower ends;
(b) an inner rod member reciprocably slidable within the outer tubular member and having upper and lower ends;
(c) a handle grip affixed to an upper end portion of one of the outer tubular member and inner rod member;
(d) a weighted anvil disposed within the outer tubular member proximate one of said upper and lower ends adapted to be impacted by one of the ends of the inner rod member upon a reciprocal stroke of the outer tubular member with respect to the inner rod member; and
(e) an attachment removably connected to one of the lower ends of the outer tubular member and the inner rod member, the attachment comprising a hollow tubular member with an open lower end for receiving a stake of a predetermined size and cross-sectional shape.

2. The slide hammer stake driver of claim 1 wherein the attachment is removably fastened to the lower end of the outer tubular member and the handle grip is affixed to the upper end portion of the inner rod member.

3. The slide hammer stake driver of claim 1 wherein the attachment is removably fastened to the lower end of the inner rod member and the handle grip is affixed to the upper end of the outer tubular member.

4. The slide hammer stake driver of claim 2 wherein said attachment includes a socket portion affixed to an upper closed end thereof, the socket dimensioned and shaped to mate with the lower end of the outer tubular member and secured by a bolt passing through aligned transversely extending holes in a lower end portion of the outer tubular member and the socket portion of the attachment.

5. The slide hammer stake driver of claim 3 wherein said attachment includes a socket portion affixed to an upper closed end thereof, the socket dimensioned and shaped to mate with the bottom lower end of the inner rod member and secured by a bolt passing through aligned transversely extending holes in a lower portion of the inner rod member and the socket portion of the attachment.

6. The slide hammer stake driver of any one of claims 1 through 4 wherein the attachment has a rectangular cross-section.

7. The slide hammer stake driver of claim 2 wherein the handle grip is of a larger diameter than a remainder of the inner rod member.

8. The slide hammer stake driver of claim 7 wherein the anvil is disposed in the outer tubular member proximate the lower end thereof.

9. The slide hammer stake driver of claim 3 wherein the anvil is disposed in the outer tubular member proximate an upper end portion thereof.

10. A slide hammer stake driver kit comprising:
(a) an elongated outer tubular member having upper and lower ends;
(b) an inner rod member reciprocably slidable within the outer tubular member and having first and second ends;
(c) a handle grip affixed to an upper end portion of one of the outer tubular member and inner rod member;
(d) a weighted anvil disposed within the outer tubular member proximate one of said upper and lower ends adapted to be impacted by one of the ends of the inner rod member upon a reciprocal stroke of the outer tubular member with respect to the inner rod member; and
(e) a plurality of attachment members adapted to be individually removably connected to one of the lower ends of the outer tubular member and the inner rod member, each of the plurality of attachment members comprising a hollow chamber with an open bottom and each adapted to contain a stake of a different cross-sectional shape and dimension.

11. The slide hammer stake driver of claim 10 wherein the attachment is removably fastened to the lower end of the outer tubular member and the handle grip is affixed to the upper end portion of the inner rod member.

12. The slide hammer stake driver of claim 10 wherein the attachment is removably fastened to the lower end of the inner rod member and the handle grip is affixed to the upper end of the outer tubular member.

13. The slide hammer stake driver of claim 11 wherein said attachment includes a socket portion affixed to an upper closed end thereof, the socket dimensioned and shaped to mate with the lower end of the outer tubular member and secured by a bolt passing through aligned transversely extending holes in a lower end portion of the outer tubular member and the socket portion of the attachment.

14. The slide hammer stake driver of claim 12 wherein said attachment includes a socket portion affixed to an upper closed end thereof, the socket dimensioned and shaped to mate with the bottom lower end of the inner rod member and secured by a bolt passing through aligned transversely extending holes in a lower portion of the inner rod member and the socket portion of the attachment.

15. A slide hammer stake driver kit as in claim 10 wherein the handle grip comprises an elastomeric sheath.
